(19) United States
(12) Patent Application Publication
(10) Pub. No.: US 2010/0108044 A1
(43) Pub. Date: May 6, 2010

(54) Combustion Chamber with Double Convex Surfaces and Double Concave Surfaces

(75) Inventor: ZHENGBAI LIU, NAPERVILLE, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: INTERNATIONAL ENGINE INTELLECTUAL PROPERTY COMPANY, LLC, WARRENVILLE, IL (US)

(21) Appl. No.: 12/265,771

(22) Filed: Nov. 6, 2008

(51) Int. Cl. F02B 23/02

(52) U.S. Cl. 123/664

(57) ABSTRACT

A combustion chamber bowl is defined in a crown of a piston for use in a cylinder of a diesel engine. The combustion chamber bowl includes a center convex spherical portion, first and second annular concave portions and an annular convex portion. The center convex spherical portion is elevated relative to a bottom plane of the combustion chamber bowl and smoothly transitions into the first concave annular portion which transitions smoothly into the second concave annular portion. The second concave annular portion smoothly transitions into the convex annular portion which smoothly transitions into the top surface of the piston crown.

### TECHNICAL FIELD OF THE INVENTION

The present invention relates to a combustion chamber for use in a diesel internal combustion engine.

### BACKGROUND OF THE INVENTION

Many attempts have been made to produce an ideal flow pattern for the charge of air and fuel within the combustion chamber of a diesel internal combustion engine. Considerations that must be taken into effect include, but are not limited to, providing for adequate power generation, minimizing the NOx entrained in the engine exhaust, and minimizing the amount of soot particulate also entrained in the engine exhaust.

It is known that changes in any one of a variety of engine design variables, such as engine compression ratio, combustion chamber shape, fuel injection spray pattern, and other variables can have an affect on both emissions and the fuel economy. Unfortunately, in the past, engine designs that have reduced emissions have also had worse fuel economy, and designs with a better fuel economy have had increased emissions.

The amount of soot that is expelled with the engine's exhaust is unsightly and generates public pressure to clean up diesel engines. Further, the amount of soot that is entrained in the engine's lubrication oil can have a deleterious effect on engine reliability. Soot is very abrasive and can cause high engine wear.

There is additionally a great deal of pressure to reduce the NOx emissions from the engine. Ever increasing regulatory demands mandate reduced levels of NOx. Typically, a combustion chamber design that is effective at reducing NOx levels has been found to increase the levels of soot and vice-versa. Additionally, doing either of the aforementioned typically reduces engine torque and power outputs.

There are numerous examples of combustion chambers formed in the crown of a piston. Notwithstanding all these prior art designs, the present inventor has recognized the need for reduction both in NOx and entrained soot while at the same time maintaining or enhancing engine torque and power outputs without adversely affecting the fuel economy of the engine.

### SUMMARY OF THE INVENTION

The present invention provides a piston for a diesel engine wherein the piston includes an improved combustion chamber bowl formed into the piston crown. The present invention provides a diesel engine which operates with reduced NOx and soot emissions, and with an increased fuel economy.

The combustion chamber bowl comprises several concave and convex surfaces. The shape and size of the bowl is advantageously configured to create a combustion chamber that compresses and ignites fuel in the chamber in such a way as to increase fuel economy and reduce emissions.

The combustion chamber bowl defined in the crown of the piston has been shown to both reduce soot entrainment and NOx and soot emissions while at the same time slightly increasing engine power output. The piston will function effectively with heads having two or more valves. A further advantage of the combustion chamber of the present invention is that by being symmetrical with respect to a combustion chamber central axis the combustion chamber is relatively easily formed in the crown of the piston.

The present invention comprises a combustion chamber assembly for use in a diesel engine and includes a combustion chamber bowl being defined in a crown of a piston, the piston having a central axis, the combustion chamber bowl having a center portion being elevated relative to a bottom plane of the combustion chamber bowl. The center portion is defined in part by a portion of a sphere, the sphere having a radius, the origin of the radius lying on the combustion chamber bowl central axis.

The combustion chamber bowl further has an outer margin, the outer margin being defined in part by two concave annular surfaces. The uppermost of the concave annular surfaces transitions into a convex annular surface near to the top surface of the piston crown.

The plurality of curved surfaces of the combustion chamber bowl have smooth tangential transitions between adjacent smooth surfaces, the smooth surfaces including the spherical center portion, the concave annular surfaces and the convex annular surface.

The present invention further encompasses a piston having the aforementioned combustion chamber bowl and method of forming the aforementioned combustion chamber bowl.

### BRIEF DESCRIPTION OF THE DRAWINGS

FIG. 1 is a side cross-sectional view of the combustion chamber bowl of the present invention; and

FIG. 2 is a bar graph showing results of the combustion chamber bowl of the present invention design vs. a prior combustion chamber bowl design in terms of BSFC, NOx emissions, and soot.

### DETAILED DESCRIPTION OF THE PREFERRED EMBODIMENT

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

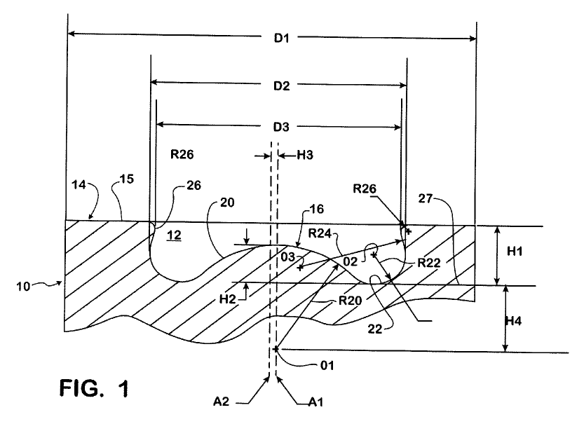

The piston of the present invention is shown generally at 10 in FIG. 1. A combustion chamber 12 of the present invention is defined in part by a crown 14 having a top surface 15. The crown 14 of the piston 10 defines in part the upper margin of the piston 10.

It should be noted that the combustion chamber bowl 12 is rotationally symmetrical about a longitudinal axis A1 that is coincident or at an offset with a center axis A2 of the piston 10.

The various radii (R), diameters (D), and heights (H) that will be described below are clearly indicated in the depiction of FIG. 1.

The piston 10 of the present invention is designed primarily for use in heavy duty diesel engines but would also be applicable to lighter duty diesel engines. The piston 10 may be utilized with two-valve or multiple-valve heads. It is desirable that the fuel be injected proximate the center of the combustion chamber bowl and that the injection pattern be radially symmetrical.

The combustion chamber bowl 12 defined in the crown 14 of the piston 10 is comprised of a plurality of curved surfaces, being both spherical and annular surfaces. The combustion chamber bowl 12 has no flat surfaces. There is a smooth, tangential transition between the various curved surfaces that define the combustion chamber bowl 12, as described in greater detail below.

Generally, the combustion chamber bowl 12 is comprised of a convex spherical surface 20, a first concave annular surface 22, a second concave annular surface 24 and a convex annular surface 26.

There are a number of parameters that control the geometry of the combustion chamber bowl 12 and thereby control the diesel engine combustion performance as well as NOx and soot emissions. A portion of a spherical surface, defined by the spherical radius R20, is located in the center portion of the combustion chamber bowl 12. The origin O1 of the spherical surface is located on the center axis A1 of the combustion chamber bowl 12. As depicted in FIG. 1, the origin O1 is below the point of intersection of the axis A1 of the combustion chamber bowl 12 and the bottom plane 27 of the combustion chamber bowl 12.

The first concave annular surface 22 has a first concavity radius R22 and is located outside of the spherical surface 20 and has an extent that defines in part an outer margin of the combustion chamber bowl 12. The first concavity radius R22 of the first concave annular surface 22 has an origin O2.

The second concave annular surface 24 has a second concavity radius R24 and is located above and generally to the outside of the first concave annular surface 22 and defines in part the outer margin of the combustion chamber bowl 12. The second concavity radius R24 of the second concave annular surface 24 has an origin O3.

A convex annular surface 26 is formed at the top of the sidewall of the combustion bowl 18. The convex annular surface 26 transitions into the top surface 15 of the piston crown 14. The convex annular surface 26 has a convexity radius R26.

The combustion chamber bowl 12 as indicated above is comprised of combined spherical and annular surfaces. It is noted that the transition between surfaces 20 and 22 is smooth and tangential, the transition between surfaces 22 and 24 is smooth and tangential, the transition between surfaces 24 and 26 is smooth and tangential and the transition between surfaces 26 and 15 is smooth and tangential. In this manner, there are no flat surfaces that define the combustion chamber bowl 12. The curves and smooth transitions as previously described promote smooth flow in the combustion chamber bowl 12 and act to reduce the thermal loading in the combustion chamber bowl 12. Further, the combustion chamber bowl 12 being rotationally symmetrical about the axis A1, it is much easier to turn the combustion chamber bowl 12 as compared to an asymmetrical combustion chamber bowl defined in a piston.

It should further be noted that the convex annular surface 26 defines a reentrant combustion chamber bowl 12 at the intersection with the top surface 15 of the crown 14, as distinct from an open combustion chamber bowl as depicted in some of the prior art.

The piston 10 has diameter D1, the combustion chamber bowl 12 has maximum diameter D2, and the convex annular surface 26 of the combustion chamber bowl 12 has diameter D3. The combustion chamber bowl 12 has a depth H1 and a center axis A1, and the convex spherical surface 20 has a height H2. The piston 10 has a center axis A2 that is a distance H3 away from the combustion chamber bowl center axis A1. The distance H3 should be between 0 and 0.08D1, and is preferably 0.

The spherical radius R20 of the convex spherical surface 20 has the origin O1 located a distance H4 below the point of intersection of the combustion chamber bowl axis A1 with the bottom plane 27 of the combustion chamber bowl 12. The distance H4 should be between 0 and 0.35D1, and is preferably 0.164D1.

The ratio of D2/D1 should be greater than 0.44 and should be less than 0.84, and is preferably 0.626.

The ratio of D3/D2 should be greater than 0.69 and should be less than 0.999, and is preferably 0.984.

The ratio of R20/D2 should be greater than 0.18 and should be less than 0.68, and is preferably 0.417.

The ratio of H1/D2 should be greater than 0.14 and should be less than 0.44, and is preferably 0.242.

The ratio of H2/D2 should be greater than 0.11 and should be less than 0.41, and is preferably 0.156.

The ratio of R22/D2 should be greater than 0.06 and should be less than 0.36, and is preferably 0.121.

The ratio of R24/D2 should be greater than 0.16 and should be less than 0.66, and is preferably 0.413.

The ratio of R26/D2 should be greater than 0.01 and should be less than 0.11, and is preferably 0.034.

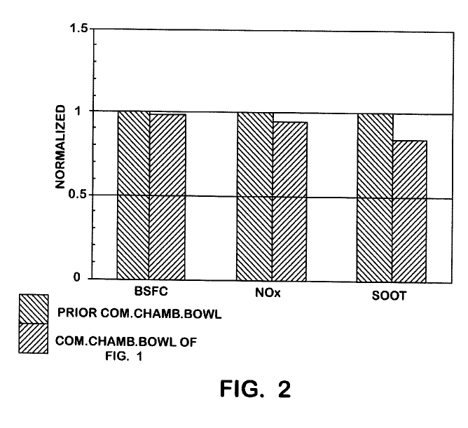

FIG. 2 shows by experimental data the effects of these configurations on BSFC, NOx emissions, and soot emissions. The Brake Specific Fuel Consumption (BSFC) is a measure of fuel consumption of the engine divided by its power (Consumption/Power). Since higher efficiency is correlated with a lower BSFC, lower BSFC numbers mean higher quality engines and better fuel economy.

It is shown that the BSFC is reduced by 0.4%, the NOx emissions are reduced by 4.3%, and the soot emissions are reduced by 14.1%.

It will be obvious to those skilled in the art that other embodiments in addition to the ones described herein are indicated to be within the scope and breadth of the present application. Accordingly, the applicant intends to be limited only by the claims appended hereto.

What is claimed is:

1. A combustion chamber bowl defined in a crown of a piston, the piston having a central axis, the piston for use in a cylinder of a diesel engine, the combustion chamber bowl comprising:
a center portion being elevated relative to a bottom plane of the combustion chamber bowl, the center portion defined by a portion of a sphere, the sphere having a spherical radius, and the combustion chamber bowl having a first concave annular surface smoothly transitioned from an outer perimeter of said center portion, said first concave annular surface having a first concavity radius, and a second concave annular surface smoothly transitioned from an outer perimeter of the first concave annular surface, said second concave annular surface having a second concavity radius, and a convex annular surface smoothly transitioned from an outer perimeter of said second concave annular surface, said convex annular surface having a convexity radius and smoothly transitioning into a top surface of the crown of said piston.

2. The combustion chamber bowl of claim 1, wherein the combustion chamber bowl has a combustion chamber bowl center axis A1, and the piston has a diameter D1 and a center axis A2 that is a distance H3 away from the combustion chamber bowl center axis A1, wherein the distance H3 is between 0.0 and 0.08D1.

3. The combustion chamber bowl of claim 1, wherein the combustion chamber bowl has a combustion chamber bowl center axis A1, and the piston has a diameter D1 and a center axis A2 that is coincident with the combustion chamber bowl axis A1.

4. The combustion chamber bowl of claim 1, wherein the combustion chamber bowl has a combustion chamber bowl center axis A1, and the piston has a diameter D1 and a center axis A2, and the spherical radius of the convex spherical surface has an origin located a distance H4 below the point of intersection of the combustion chamber bowl axis A1 with a bottom plane of the combustion chamber bowl, and the distance H4 is between 0.0 and 0.35D1.

5. The combustion chamber bowl of claim 1, wherein the combustion chamber bowl has a combustion chamber bowl center axis A1, and the piston has a diameter D1 and a center axis A2, and the spherical radius of the convex spherical surface has an origin located a distance H4 below the point of intersection of the combustion chamber bowl axis A1 with a bottom plane of the combustion chamber bowl, and the distance H4 is about 0.164D1.

6. The combustion chamber bowl of claim 1, wherein the combustion chamber bowl has a combustion chamber bowl center axis A1 and a maximum diameter D2, and the piston has a diameter D1 and a center axis A2, the ratio of D2/D1 is greater than 0.44 and less than 0.84.

7. The combustion chamber bowl of claim 1, wherein the combustion chamber bowl has a combustion chamber bowl center axis A1 and a maximum diameter D2, and the piston has a diameter D1 and a center axis A2, the ratio of D2/D1 is about 0.63.

8. The combustion chamber bowl of claim 1, wherein the combustion chamber bowl has a combustion chamber bowl center axis A1 and a maximum diameter D2, the piston has a diameter D1 and a center axis A2, and the convex annular surface has diameter D3, the ratio of D3/D2 is greater than 0.69 and less than 0.999.

9. The combustion chamber bowl of claim 1, wherein the combustion chamber bowl has a combustion chamber bowl center axis A1 and a maximum diameter D2, the piston has a diameter D1 and a center axis A2, and the convex annular surface has diameter D3, the ratio of D3/D2 is about 0.98.

10. The combustion chamber bowl of claim 1, wherein the combustion chamber bowl has a combustion chamber bowl center axis A1 and a maximum diameter D2, the piston has a diameter D1 and a center axis A2, and the spherical radius is R20, the ratio of R20/D2 is greater than 0.18 and less than 0.68.

11. The combustion chamber bowl of claim 1, wherein the combustion chamber bowl has a combustion chamber bowl center axis A1 and a maximum diameter D2, the piston has a diameter D1 and a center axis A2, and the spherical radius is R20, the ratio of R20/D2 is about 0.42.

12. The combustion chamber bowl of claim 1, wherein the combustion chamber bowl has a maximum diameter D2 and a depth H1 to a bottom plane of the combustion chamber bowl, the ratio of H1/D2 is greater than 0.14 and less than 0.44.

13. The combustion chamber bowl of claim 1, wherein the combustion chamber bowl has a maximum diameter D2 and a depth H1 to a bottom plane of the combustion chamber bowl, the ratio of H1/D2 is about 0.24.

14. The combustion chamber bowl of claim 1, wherein the combustion chamber bowl has a combustion chamber bowl center axis A1 and a maximum diameter D2, and the convex spherical surface has a height H2 from a bottom plane of the combustion chamber bowl, and the ratio of H2/D2 is greater than 0.11 and less than 0.41.

15. The combustion chamber bowl of claim 1, wherein the combustion chamber bowl has a combustion chamber bowl center axis A1 and a maximum diameter D2, and the convex spherical surface has a height H2 from a bottom plane of the combustion chamber bowl, and the ratio of H2/D2 is about 0.16.

16. The combustion chamber bowl of claim 1, wherein the combustion chamber bowl has a combustion chamber bowl center axis A1 and a maximum diameter D2, and the first concavity radius is R22, the ratio of R22/D2 is greater than 0.06 and less than 0.36.

17. The combustion chamber bowl of claim 1, wherein the combustion chamber bowl has a combustion chamber bowl center axis A1 and a maximum diameter D2, and the first concavity radius is R22, the ratio of R22/D2 is about 0.12.

18. The combustion chamber bowl of claim 1, wherein the combustion chamber bowl has a combustion chamber bowl center axis A1 and a maximum diameter D2, and the second concavity radius is R24, the ratio of R24/D2 is greater than 0.16 and less than 0.66.

19. The combustion chamber bowl of claim 1, wherein the combustion chamber bowl has a combustion chamber bowl center axis A1 and a maximum diameter D2, and the second concavity radius is R24, the ratio of R24/D2 is about 0.41.

20. The combustion chamber bowl of claim 1, wherein the combustion chamber bowl has a combustion chamber bowl center axis A1 and a maximum diameter D2, and the convexity radius is R26, the ratio of R26/D2 is greater than 0.01 and less than 0.11.

21. The combustion chamber bowl of claim 1, wherein the combustion chamber bowl has a combustion chamber bowl center axis A1 and a maximum diameter D2, and the convexity radius is R26, the ratio of R26/D2 is about 0.034.

22. The combustion chamber bowl of claim 1, wherein the combustion chamber bowl has a combustion chamber bowl center axis A1 and a maximum diameter D2 and a depth H1 to a bottom plane of the combustion chamber bowl, the piston has a diameter D1 and a center axis A2, the convex spherical surface has a height H2 from the bottom plane of the combustion chamber bowl, the spherical radius is R20, the first concavity radius is R22, the second concavity radius is R24, the convex annular surface has diameter D3, and the convexity radius is R26:
the ratio of D2/D1 is greater than 0.44 and less than 0.84;
the ratio of D3/D2 is greater than 0.69 and less than 0.999;
the ratio of R20/D2 is greater than 0.18 and less than 0.68;
the ratio of H1/D2 is greater than 0.14 and less than 0.44;
the ratio of H2/D2 is greater than 0.11 and less than 0.41;
the ratio of R22/D2 is greater than 0.06 and less than 0.36;
the ratio of R24/D2 is greater than 0.16 and less than 0.66; and
the ratio of R26/D2 is greater than 0.01 and less than 0.11.

23. The combustion chamber bowl of claim 22, wherein the piston center axis A2 is a distance H3 away from the combustion chamber bowl center axis A1, wherein the distance H3 is between 0.0 and 0.08D1.

24. The combustion chamber bowl of claim 23, wherein the spherical radius of the convex spherical surface has an origin located a distance H4 below the point of intersection of the combustion chamber bowl axis A1 with the bottom plane of the combustion chamber bowl, and the distance H4 is between 0.0 and 0.35D1.

25. The combustion chamber bowl of claim 1, wherein the combustion chamber bowl has a combustion chamber bowl center axis A1 and a maximum diameter D2 and a depth H1 to a bottom plane of the combustion chamber bowl, the piston has a diameter D1 and a center axis A2, the convex spherical surface has a height H2 from the bottom plane of the combustion chamber bowl, the spherical radius is R20, the first concavity radius is R22, the second concavity radius is R24, the convex annular surface has diameter D3, and the convexity radius is R26:
the ratio of D2/D1 is about 0.63;
the ratio of D3/D2 is about 0.98;
the ratio of R20/D2 is about 0.42;
the ratio of H1/D2 is about 0.24;
the ratio of H2/D2 is about 0.16;
the ratio of R22/D2 is about 0.12;
the ratio of R24/D2 is about 0.41; and
the ratio of R26/D2 is about 0.034.

26. The combustion chamber bowl of claim 25, wherein the spherical radius of the convex spherical surface has an origin located a distance H4 below the point of intersection of the combustion chamber bowl axis A1 with the bottom plane of the combustion chamber bowl, and the distance H4 is between 0.0 and 0.35D1.
